(19) United States
(12) Patent Application Publication
(10) Pub. No.: US 2010/0081493 A1
(43) Pub. Date: Apr. 1, 2010

(54) Gaming machine with extensive symbols

(75) Inventor: Kenichi Kamano, Las Vegas, NV (US)

Correspondence Address: MASUVALLEY & PARTNERS, 8765 AERO DRIVE, SUITE 312, SAN DIEGO, CA, 92123, US

(73) Assignee: Konami Gaming, Inc., Las Vegas, NV (US)

(21) Appl. No.: 12/286,684

(22) Filed: Sep. 30, 2008

(51) Int. Cl. A63F 9/24; A63F 13/00

(52) U.S. Cl. 463/20

(57) ABSTRACT

The present invention is a gaming machine for providing a game play and a payout according to a game result, including a storage device which stores a game using a symbol with a function, an executor which executes the game and an extended device which adds other function to the symbol, wherein the extended device works independently of the executor.

### TECHNICAL FIELD

The present invention relates to a gaming machine provided with, in addition to a game device for executing a normal game, an extended device capable of adding a function to the game.

### BACKGROUND OF THE INVENTION

Conventionally, a gaming machine installed in a casino or the like is provided with a game device for executing a normal game, and the game device executes almost all game elements provided in the gaming machine. For example, an arrangement of symbols after rotation of a reel, adjustment of a payout, execution of a secondary game, and the like performed in a slot game are executed by the game device. As described above, the game provided in the gaming machine is conventionally executed by using the game device, and the gaming machine which provides the game by using a different system is desired to be provided on the market in order to provide the game with a lot of variety. Also, harmful effects resulting from the problems that a unit executing the game is only a game device, for example, simplicity of a variety or a volatility of the game, and change of an entire setting of the game device to modify a portion of the game content, are desired to be solved.

### SUMMARY OF THE INVENTION

One aspect of the present invention may be a gaming machine for providing a game play and a payout according to a game result, including a storage device which stores a game using a symbol with a function, an executor which executes the game and an extended device which adds other function to the symbol, wherein the extended device works independently of the executor.

If the extended device is used, it is possible to add the other function to a symbol, and add the secondary game. In this case, the extended device is independent of the game device, and therefore game property and volatility of the game to be executed by the game device can be significantly changed by a function of the extended device without changing content of the game device. Such extended device can also reduce reapplication time and cost.

The extended device may add the other function that the symbol plays a role as a wild symbol or a jackpot symbol. The extended device may add the other function that a secondary game is begun. The secondary game may be a jackpot game or a roulette game. The executor may execute the game with a trigger condition and the extended device may add another trigger condition to the trigger condition.

By employing the above-described configuration, a property of a game can be significantly changed without changing content of the game device. This causes volatility of the game, and the like to be changed, and therefore can more entertain a player and raise expectations and the like of the player.

The gaming machine further may include a processor, which synchronizes a play cycle in the executor and the extended device. The extended device may implement the other function added to the symbol.

Another aspect of the present invention may be a gaming system for providing game play on a display and paying out award, including a gaming device, including (i) a storage device, which stores a game using symbols with function and (ii) an executor, which executes the game on the display, and a controller which adds other function to the symbols, wherein the controller works independently of the gaming device.

If the extended device is used, it is possible to add the other function to a symbol and add the secondary game. In this case, the extended device is independent of the game device, and therefore game property and volatility of the game to be executed by the game device can be significantly changed by a function of the extended device without changing content of the game device. Such extended device can also reduce reapplication time and cost.

The gaming system further may include a managing system, the gaming device may transmit play activity information to the managing system, and the managing system may transmit operating information related to the other function to the controller.

By employing the above-described configuration, a casino manager or the like can arbitrarily change content of a game to be executed in the gaming machine. That is, the casino manager or the like can issue an instruction to the controller so as to add any function to the game content through the gaming system, and therefore the casino manager can control the game. By doing so, the casino manager can control the game content in consideration of a player's psyche with viewing a play situation, and therefore needs of the player can be further satisfied.

The controller may add the other function for paying out additional award when the award is paid out according to the game play. The total of the award and additional award may be in multiples of the award. The controller may add the other function for providing a coupon or a complimentary. The controller may implement the other function added to the symbols.

By employing the above-described configuration, a property of a game can be significantly changed without changing content of the game device. This causes volatility of the game to be changed, and therefore can more entertain a player and raise expectations and the like of the player.

Another aspect of the present invention may be a method for playing a game, including the steps of receiving wager, presenting a first game with a set of symbols by a first means, adding element to the first game by a second means, playing a second game which has the element added to the first game, analyzing outcome of the second game, determining whether the outcome is winning outcome and awarding a reward when the outcome is winning outcome, wherein the first means works independently of the second means.

When the extended device is used, it is possible to add the other function to a symbol and add the secondary game. In this case, the extended device is independent of the game device, and therefore game property and volatility of the game to be executed by the game device can be significantly changed by a function of the extended device without changing content of the game device. Such extended device can also reduce reapplication time and cost.

The method may include the step of presenting a symbol with a function by the first means and the step of adding the other function to the symbol by the second means. The element may be a bonus. The bonus game may be a jackpot game or a roulette game. The method may include the step of presenting a set of symbols with a trigger condition by the first means and the step of adding another trigger condition to the trigger condition by the second means.

The adding step may be the step of adding the element for paying out additional award when the award is pay out according to the game play. The method further may include the step of implementing the element by the second means.

By employing the above-described configuration, a property of a game can be significantly changed without changing content of the game device. This allows volatility of the game to be changed, and therefore can more entertain a player and raise expectations and the like of the player.

### BRIEF DESCRIPTION OF THE DRAWINGS

FIG. 1 is a perspective view illustrating an example of a gaming machine of the present invention.

FIG. 2 is a diagram illustrating a configuration of the gaming machine according to the present invention.

FIG. 3 is a diagram illustrating a configuration of a managing system according to the present invention.

FIG. 4 is a diagram illustrating a relationship between a game device and an extended device.

FIG. 5 is a diagram illustrating a case where a plurality of game devices is present.

FIGS. 6 and 7 are diagrams illustrating an example of a function executable by the extended device according to the present invention.

FIG. 8 is a diagram illustrating an example of a function executable by the extended device according to the present invention.

FIGS. 9 to 11 are diagrams illustrating an example of a function executable by the extended device according to the present invention.

FIG. 12 is a diagram illustrating an example of award combinations created by the game device and extended device.

FIG. 13 is an example of a flowchart of operations executed by the gaming machine according to the present invention.

FIG. 14 is an example of a flowchart of operations performed by the gaming machine according to the present invention.

### DETAILED DESCRIPTION OF THE INVENTION

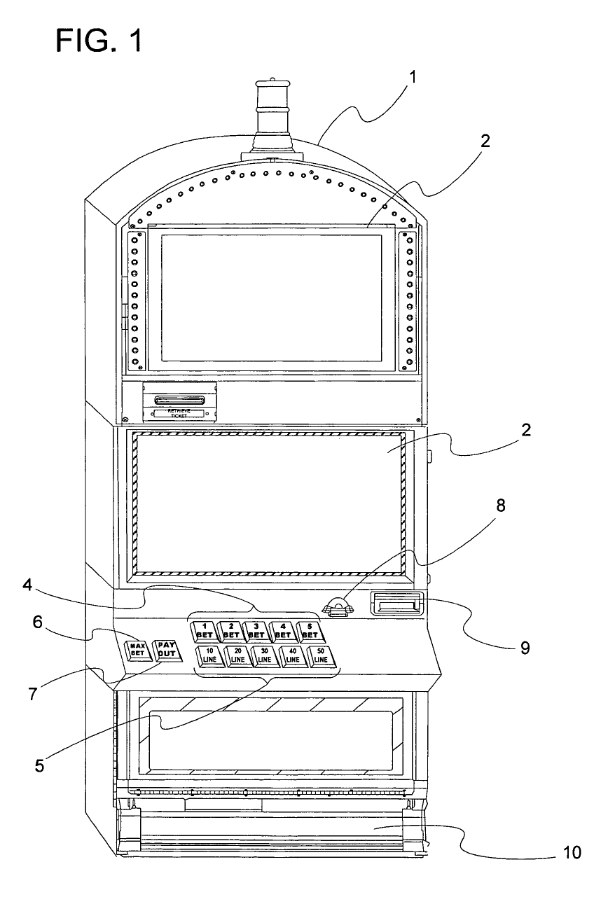

FIG. 1 is a perspective view illustrating an example of a gaming machine of the present invention. As illustrated in FIG. 1, a gaming machine 1 is provided with two displays 2. Immediately below the displays 2, a BET switch 4, select switch 5, MAX BET switch 6, PAYOUT switch 7, coin slot 8, and inlet/outlet for banknote or the like 9 are provided. The BET switch 4 has five switches respectively for “1BET” to “5BET”. The select switch 5 has five switches respectively for “1select” to “5select”. Also, in a lower part of the gaming machine 1, a coin payout port 10 is provided.

On the displays 2, a display necessary for a player to play a game is provided. For example, on the displays 2, a display for playing a primary game or secondary game is provided. On the displays 2, for example, playing cards used in a card game, a wheel and coins used in a roulette game, reels and features used in a reel game, or the like are displayed. Also, a display for the player to select the type of a progressive game or bonus game, or one for the player to select the feature is provided. Alternatively, on the displays 2, a progressive game screen, or the like, on which an amount of money the player may win may be displayed. Still alternatively, on the displays 2, presentation according to progress of a game, a credit being inputted into the gaming machine by the player, a play history of the player, or the like may be displayed.

The BET switch 4 is a switch for putting a bet in a game. The player can use the BET switch 4 to put any of the bets from “1BET” to “5BET” for a single play of the game. The select switch 5 is a switch for selecting, for example, a card the player would like to discard, a line on reels, or the like. The numbers of switches included in the BET switch 4 and select switch 5 are not limited to five, respectively, but may be any numbers. Alternatively, the gaming machine 1 may have, for example, a switch for betting “10BET”, or a switch for “10select”.

The MAXBET switch 6 is a switch for putting in the maximum bet that the player can bet on a single play of a game. The PAYOUT switch 7 is a switch for paying out an amount of money credited to the gaming machine back to the player. The coin slot 8 is a hole for the player to credit coins to the gaming machine. The inlet/outlet for banknote or the like 9 is a hole used for inserting a banknote or cash card into the gaming machine, or paying out an amount of credited money. The coin payout port 10 is intended for paying out the amount of money credited to the gaming machine back to the player.

The gaming machine according to the present invention is not limited to the above, but may be provided with various functions in addition to the above functions, or omit some of the above functions. For example, the gaming machine may have a lighting device for lighting the gaming machine with one or more different colors when the player enters the secondary game. Alternatively, the gaming machine may have a device for vibrating the entire game machine or outputting music when the player enters the secondary game. Still alternatively, the gaming machine 1 may have three or more displays. Yet alternatively, the gaming machine 1 may have a switch for again selecting “BET” the player bet on a previous play of the game.

Also, a reel, wheel, or the like used in a game may not necessarily be displayed on the displays, but the gaming machine 1 may be loaded with a stepper (mechanical reel), mechanical wheel, or the like. Further, a display used for a plurality of gaming machines in common may exist.

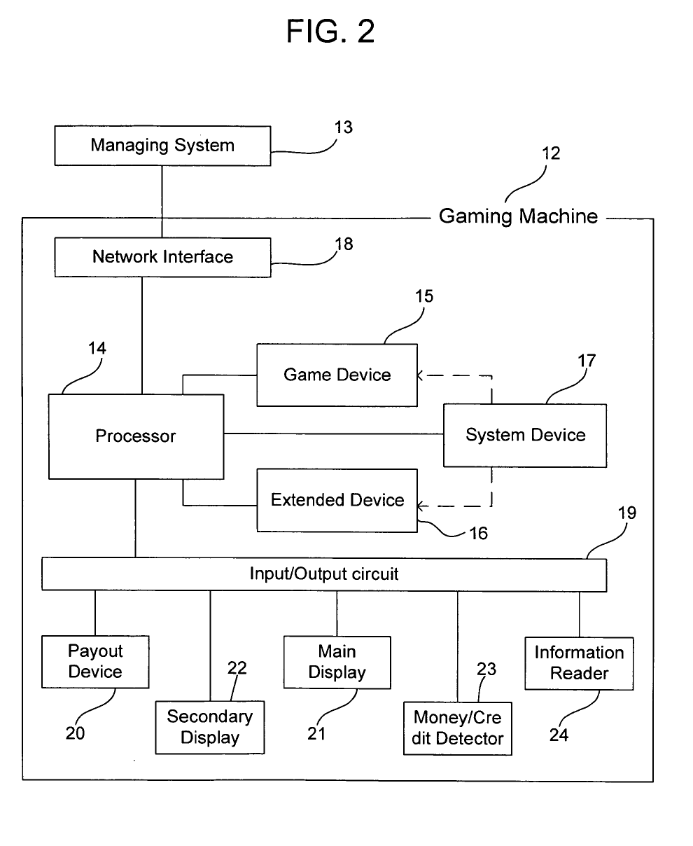

FIG. 2 is a diagram illustrating a configuration of the gaming machine according to the present invention. In FIG. 2, a gaming machine 12 and managing system 13 are illustrated. The gaming machine 12 is a machine for providing a game to a player, and installed on a casino floor, or the like. On the other hand, the managing system 13 is a system provided such that the manager on the casino side can operate the gaming machine 12. Through the managing system 13, the manager can change a setting of the gaming machine 12, or refer to information accumulated in the gaming machine 12.

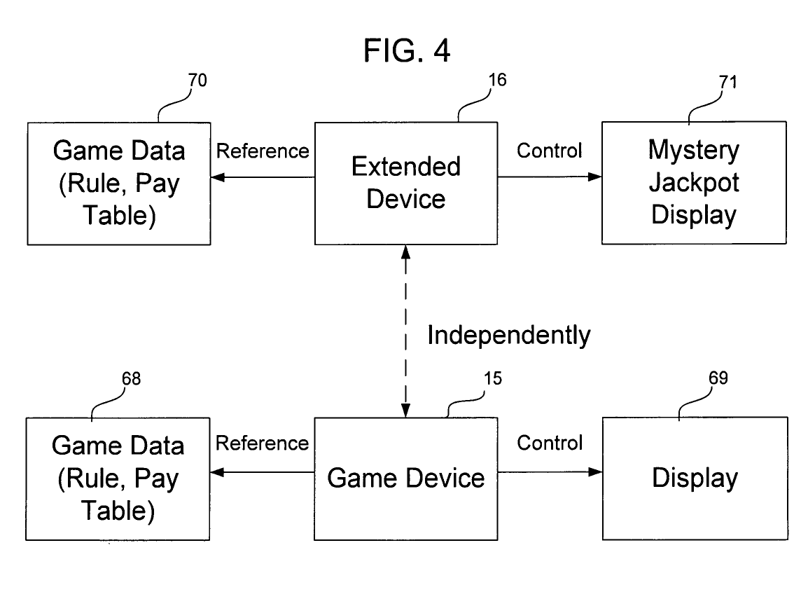

The gaming machine 12 is installed with a processor 14, which controls various devices and the like. As the various devices, a game device 15, extended device 16, system device 17, network interface 18, and input/output circuit 19 are provided. The processor 14 is adapted to be able to make contact with the managing system 13 through the network interface 18. The game device 15 is a part that controls a basic portion of the game to be provided to the player. The extended device 16 is a device that operates completely independently of the game device 15, and may provide a game completely independent of the game to be provided by the game device 15 or provide a game having content related to the game to be provided by the game device 15. The game device 15 and extended device 16 will be described in detail with reference to FIG. 4 and subsequent drawings.

On the other hand, the input/output circuit 19 is connected with a payout device 20, main display 21, secondary display 22, money/credit detector 23, and information reader 24. The payout device 20 is a device for paying out a credit or award depending on a game result. The main display 21 is a display for displaying a game to be provided by the game device 15 or the like. The secondary display 22 is a display for displaying a game to be provided by the extended device 16 or the like. The money/credit detector 23 is a detector for detecting cash or a credit card inserted into the machine by the player. The information reader 24 is a reader for reading information on the player from the inserted player's card or the like. The processor 14 is set through the input/output circuit 19 so as to be able to operate such devices.

Meanwhile, the system device 17 plays a role of making synchronization of a play cycle among the above-described various devices. For example, the system device 17 transmits an instruction to start a game on the display upon receipt of an instruction from the player indicating that a bet has been placed, or transmits an instruction to display a game result upon receipt of an instruction indicating that a predetermined game has been completed. Also, the system device 17 transmits an instruction for payout according to a display of the game result. Alternatively, the system device 17 may realize a function of matching the play cycles of the game device 15 and extended device 16.

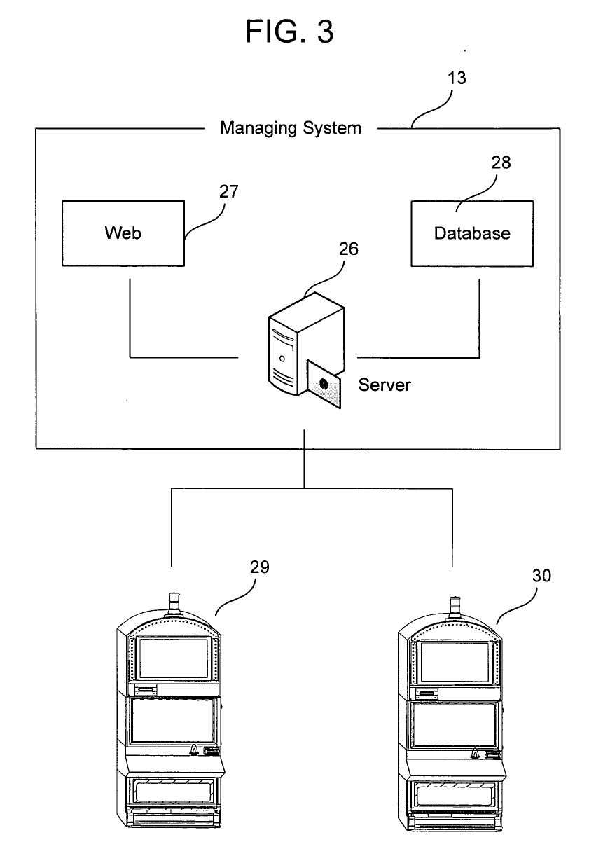

FIG. 3 is a diagram illustrating a configuration of the managing system according to the present invention. In FIG. 3, the managing system 13, and gaming machines 29 and 30 are illustrated. Components of the managing system 13 may include, for example, a server 26, web 27, database 28, and the like. The casino manager can access the server 26 to acquire information from the web 27 or database 28, or store information in the database 28. Also, the casino manager can use the managing system 13 to control a plurality of the gaming machines, and store/acquire pieces of information into/from the gaming machines. Said pieces of information include, for example, game content, game rule, pay table, value of cash or credit, individual information on a player, play activity information, and the like.

Note that, in FIGS. 2 and 3, the components of the gaming machine and managing system according to the present invention are described; however, the components are not limited to them, but unshown components may be provided. For example, the numbers of the game devices 15 and extended devices 16 may not necessarily be one, respectively, but pluralities of the gaming devices 15 and extended devices 16 may be provided. Also, even if any of the components illustrated in FIGS. 2 and 3 is missing, the gaming machine and managing system of the present invention can play their roles. For example, it goes without saying that even if the secondary display 22, information reader 24, and the like are missing from said gaming machine, features of the present invention can be realized.

FIG. 4 is a diagram illustrating a relationship between the game device and the extended device. In FIG. 4, the game device 15 and extended device 16 are illustrated. These devices are characterized by operating independently of each other. Also, these devices can provide games to players, or refer to pieces of game data (game rules, pay tables, and the like) 68 and 70, independently of each other. For example, the game device 15 can use a display 69 to provide various games to the player, whereas, independently of this, the extended device 16 may use a display 71 to provide a game completely different from that provided by the game device 15. In this case, the extended device 16 may provide the same type of game as that provided by the game device 15. Also, with the game device 15 providing a certain game to the player, the extended device 16 may play a role of adding some sort of function to the game provided by the game device 15. In other words, the extended device 16 is a device for changing the characteristics of the game provided the gamed device 15 by adding a function thereto. Note that the games respectively provided by the game device 15 and extended device 16 may not necessarily be played on separate displays, but may be played on the same display.

Specifically, we assume that, for example, the game device 15 provides a slot game displaying symbols; as a result of a player's play of the game, the symbols are arrayed on a display; and a credit is determined to be paid out. In this case, because the symbols are arrayed on the display, the extended device 16 may, in addition to paying out the predetermined credit, further pay out a credit with reference to the game result. Alternatively, the extended device 16 may, in addition to paying out the predetermined credit, additionally issue a coupon, complimentary ticket, gift certificate or the like. On the other hand, for example, the game device 15 may provide a normal game (slot game, card game, keno game or the like), and depending on a result of the game (e.g., in the case where symbols are arrayed, or in other case), the extended device 16 may provide another game (secondary game, or the like) to the player.

The extended device 16 may add a function to a symbol or provide another game at any time. For example, the extended device 16 can refer to game content, game result, game rule, and the like controlled by the game device 15, and therefore may operates at a time when the game device 15 executes a predetermined operation. The time when the game device 15 executes the predetermined operation may be any time, such as a time when a winning combination is displayed, the number of rotations of a reel reaches a predetermined number of times, a certain period of time elapses, a player performs a certain operation, a BET amount reaches a predetermined amount, a payout exceeds a certain amount or a predetermined number of players play.

On the other hand, the extended device 16 may add a function to a symbol at its own time without referring to the game result or the like of the game device 15. The own time for this case includes, for example, a time when a certain period of time elapses, a BET amount reaches a predetermined amount, a payout exceeds a certain amount, or the like. Alternatively, the extended device 16 may, without referring to the game result or the like of the game device 15, add a function to a symbol at a time when receiving an instruction from a component other than the game device 15.

If the extended device 16 refers to the game result or the like of the game device 15, it may refer to past game content, game result, game rule, or the like, or only to a present play situation. For example, if the extended device 16 refers to the past game result, it may refer to a game history before a reel rotates a predetermined number of times (e.g., 50 rotations, 100 rotations or the like), or a game history several hours before. Alternatively, the extended device 16 may comprehensively refer to a history of a game that had been played during a predetermined period of time (from three hours before to two hours before or the like) or a history of a game that had been played within a predetermined range of rotations of a reel (from previous 200 rotations to previous 100 rotations or the like).

Also, the extended device 16 may be set to add a function to a symbol for an event to potentially occur in the future. For example, the extended device 16 may add a function to a symbol after the game device 15 has rotated a reel a predetermined number of times. For example, the extended device 16 may be set to add a function to a symbol when the game device 15 displays a predetermined single symbol.

On the other hand, said managing system 13 can operate the extended device 16, and, for example, according to an instruction from the management system 13, the extended device 16 may add a function to a symbol. Because a configuration is made as described, the casino manager may perform payout from the gaming machine at his/her own time. Generally, if play activity information is transmitted from the gaming machine to the managing system 13, the managing system 13 transmits to the extended device 16 an instruction to add a function to a symbol.

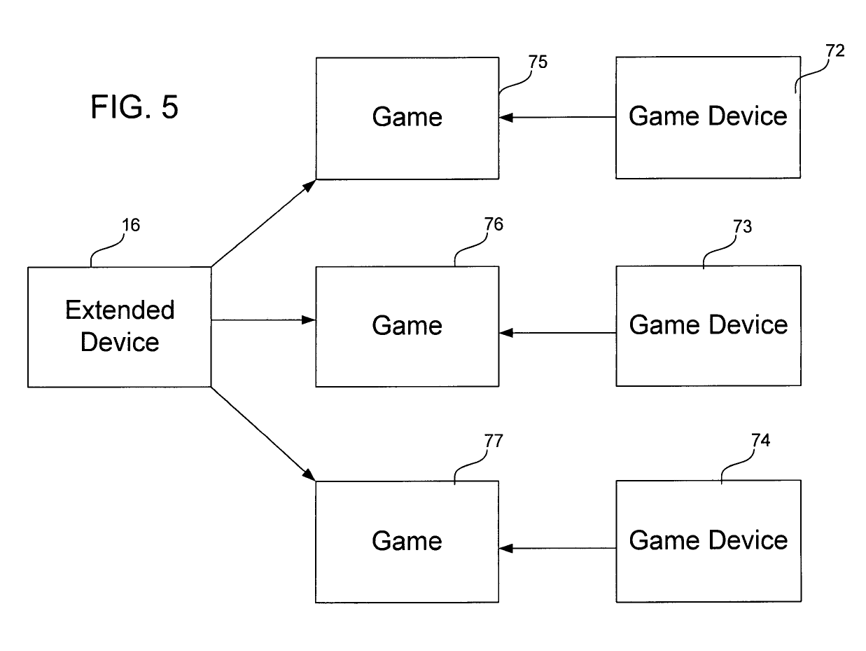

FIG. 5 is a diagram illustrating a case where a plurality of game devices is present. In FIG. 5, three game devices 72, 73 and 74 and the extended device 16 are illustrated. The three game devices 72, 73, and 74 respectively control games 75, 76, and 77. As illustrated, the extended device 16 adds functions to the three games 75, 76, and 77. As described, the one extended device is present not only for one game device, but the extended device adding the functions to the plurality of game devices may be present. On the other hand, a plurality of extended devices adding functions to one game device may be present. In the former case, times when the extended device adds the functions may be the same or different for each of the plurality of game devices. In addition, the plurality of game devices 72, 73, and 74 may be respectively loaded in one gaming machine, or in a plurality of gaming machines to provide the games in the respective gaming machines.

Generally, to change content of a game to be executed by the game device, a setting of the game content should be changed for each of the game devices. Also, when content of another game such as a secondary game is changed, it is necessary to change the content and then reapply the changed content. Such setting change of the game content and reapplication typically require significant time. As described above, if the extended device is used, it is possible to add a function to a symbol, and add the secondary game. In this case, the extended device is independent of the game device, and therefore game property and volatility of the game to be executed by the game device can be significantly changed by a function of the extended device without changing content of the game device.

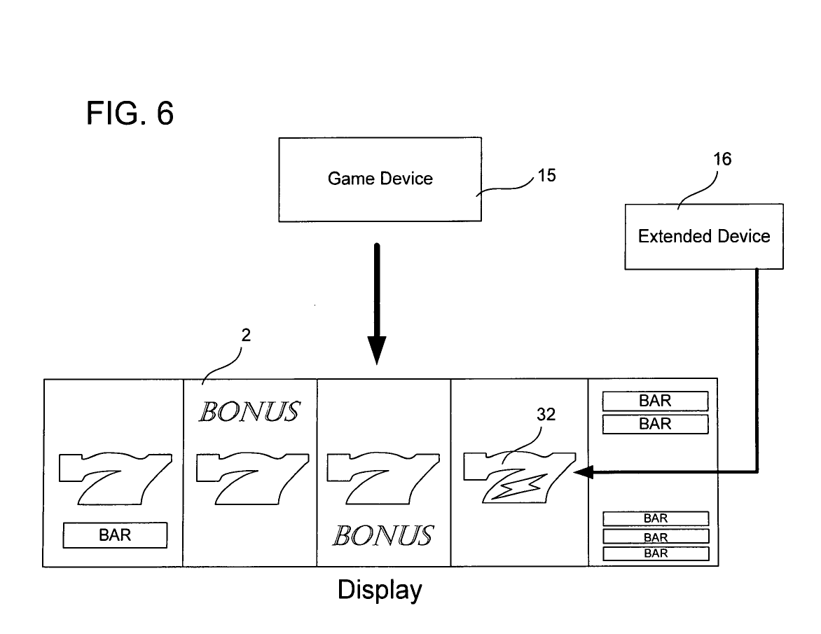

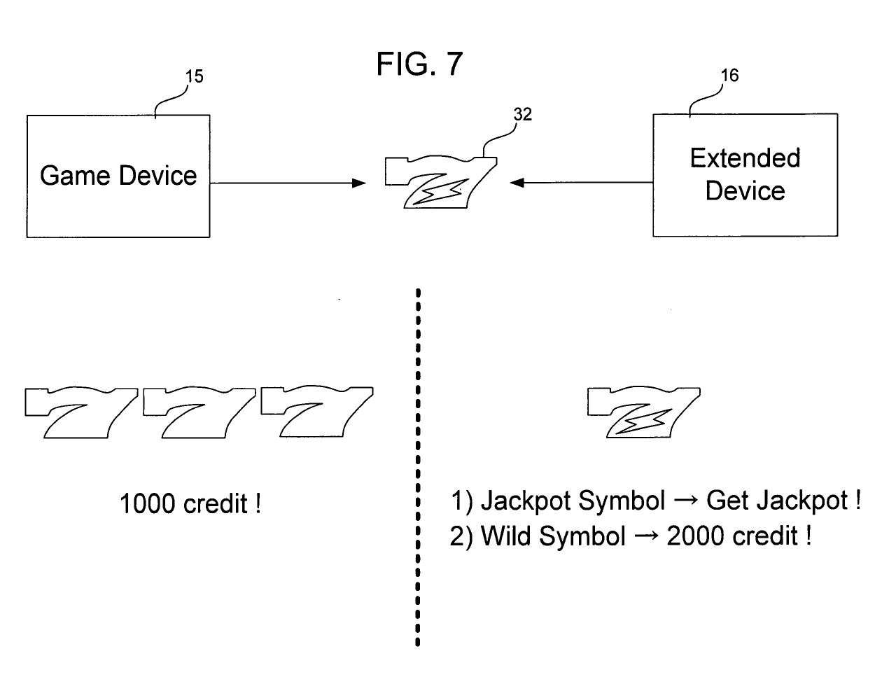

Hereinafter, specific examples of a function, game, and the like the extended device can add are described. FIGS. 6 and 7 are diagrams illustrating an example of a function executable by the extended device according to the present invention. In FIG. 6, the game device 15 is illustrated, and a reel game executed by the game device is displayed on the display 2. Also, in FIG. 6, the extended device 16 is illustrated, and the extended device plays a role of adding a function to a symbol appearing in the reel game executed on the display 2.

An example is taken to give a description. For example, in the center of the display 2, three symbols “7” are arrayed, and beside the symbols, a symbol 32 is aligned. If the extended device 16 does not add any function to a symbol, the symbol 32 is not involved in payout or bonus at all, and as illustrated in FIG. 7, a 1000 credit is paid out to a player. On the other hand, for example, if the extended device 16 adds a function of playing a role as a jackpot symbol to the symbol 32, the symbol 32 appearing on the display 2 will enable the player to get a jackpot award. Alternatively, for example, if the extended device 16 adds a function of playing a role as a wild symbol to the symbol 32, the symbol 32 is considered to play the same role as the symbol “7”, so that the four symbols “7” are considered to be arrayed in the center of the display 2, and therefore an amount (e.g., 2000 credit) larger than that for the case where the three symbols “7” are arrayed will be paid out.

If the extended device 16 adds a function, it may realize the additional function at its own discretion because it originally has information to be added to a symbol. On the other hand, because a symbol operated by the game device 15 originally has a plurality of attributes (e.g. in the case of attributes respectively enabling some symbol to become a jackpot symbol and a wild symbol, etc.), the extended device 16 may refer to such attributes to select one or more of the attributes, and add the attributes to the symbol such that the symbol can realize the attributes.

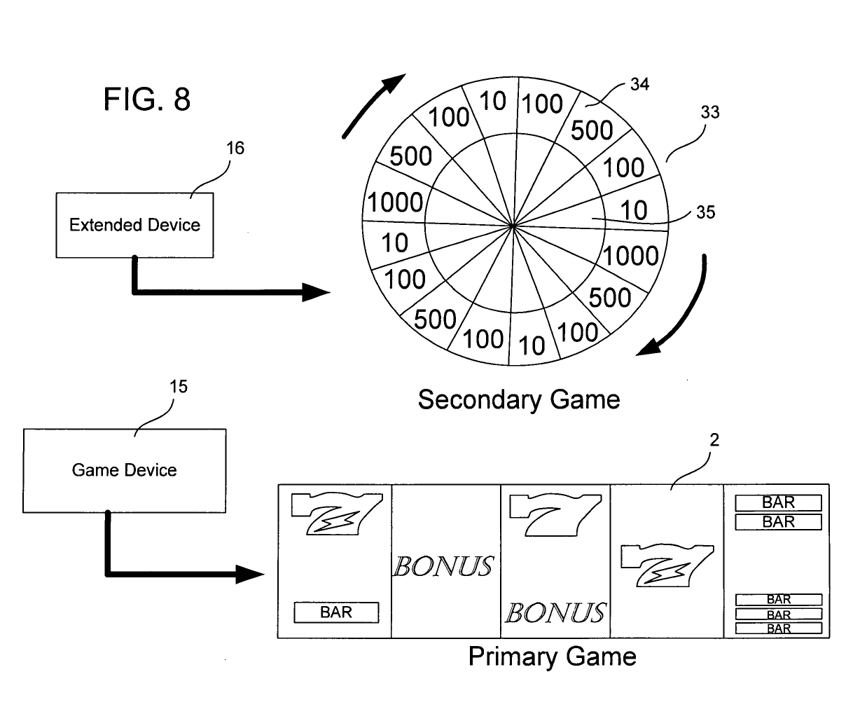

FIG. 8 is a diagram illustrating an example of a function executable by the extended device according to the present invention. In FIG. 8, a primary game (reel game) executed by the game device 15 is displayed on the display 2. The extended device 16 refers to the symbol of the primary game to execute a secondary game. Here, the secondary game is a wheel game, and a wheel 33 is used to proceed with the secondary game. The wheel 33 has, for example, an outer frame 34 and inner frame 35, and on the outer frame, payouts are displayed. The secondary game executable by the extended device is not particularly limited, but a bonus game using a reel, bonus game making a player select any of a plurality of objects, or the like is executable.

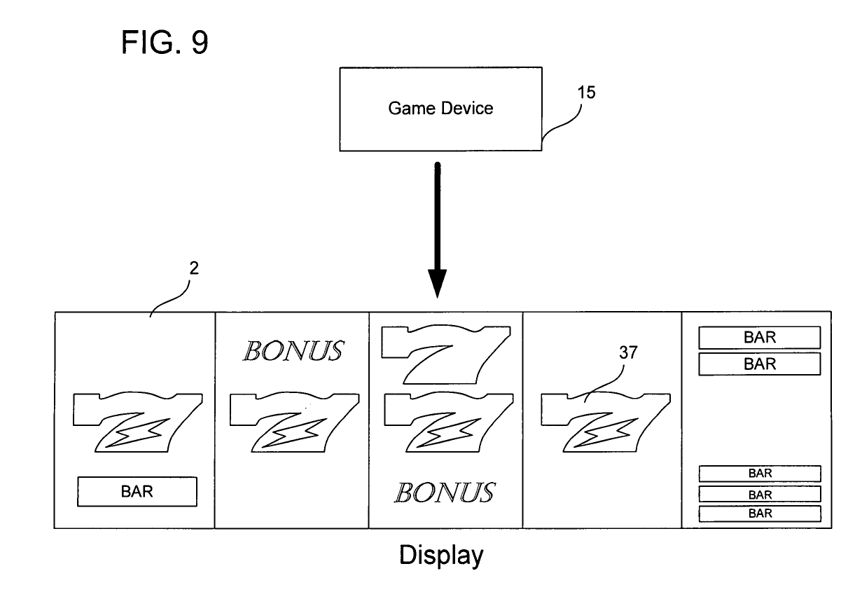

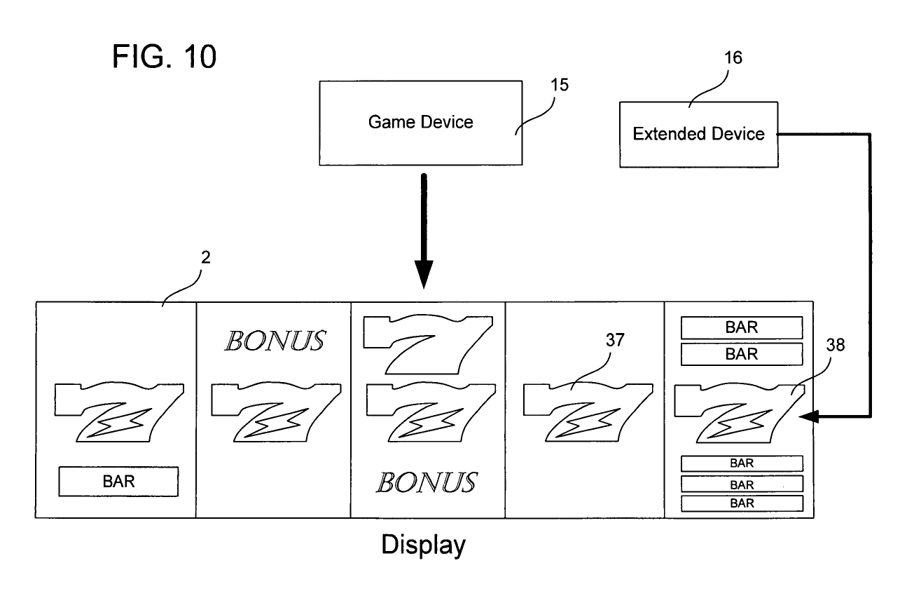

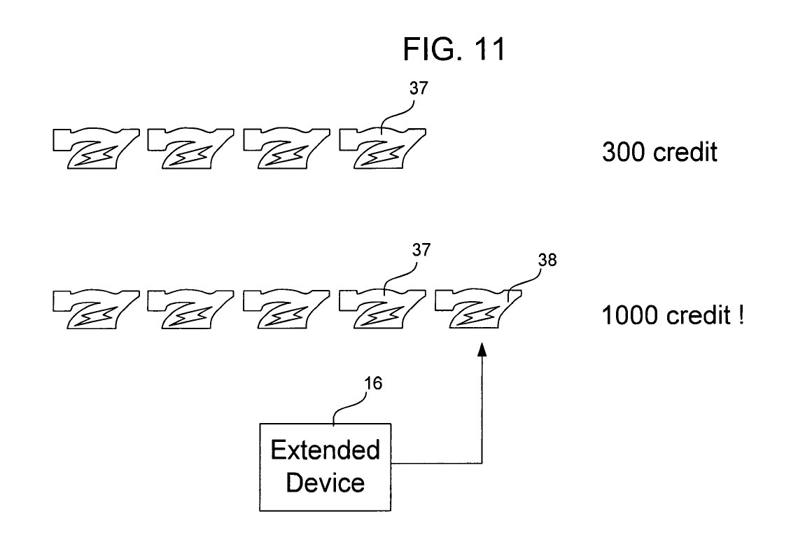

FIGS. 9 to 11 are diagrams illustrating an example of a function executable by the extended device according to the present invention. In FIG. 9, the game device 15 executing a reel game on the display 2 is illustrated. In the center of the display, four symbols 37 are arrayed. In this case, the extended device does not particularly add a function, and as illustrated in FIG. 11, a 300 credit is paid out. FIG. 10 illustrates a state where the extended device 16 has added a symbol onto the reel display. As can be seen from FIG. 10, in the center of the rightmost reel on the display, the symbol 38 is added by the extended device. When this state is reached, the four symbols 37 as a game result by the game device and the symbol 38 added by the extended device are taken into account to pay out a 1000 credit as illustrated in FIG. 11. As described, the extended device not only adds a function to a symbol present in a game executed by the game device, but may also display a new symbol on a display.

On the other hand, the extended device may delete a symbol present in a game executed by the game device. For example, even if a program is set to array four symbols on a display during execution of a reel game by the game device, the extended device may delete one of the four symbols to actually display the three symbols on the display.

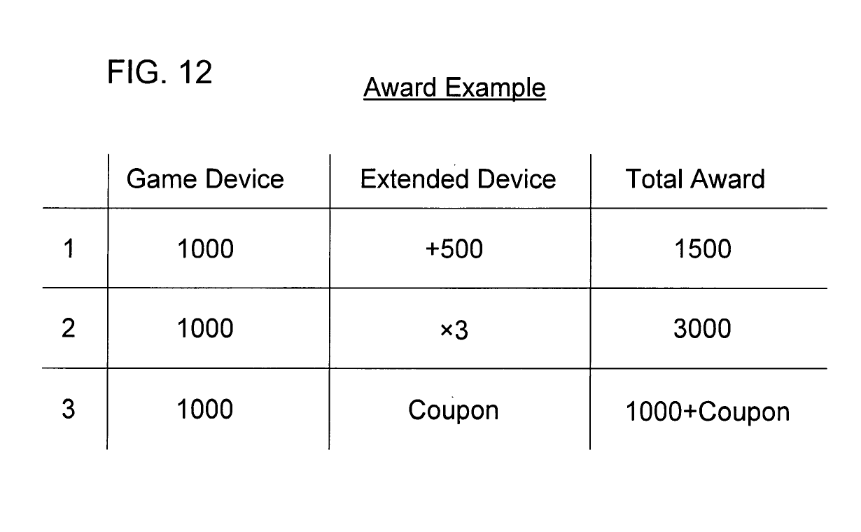

FIG. 12 is a diagram illustrating an example of award combinations created by the game device and extended device. FIG. 12 illustrates three patterns, i.e., No. 1 to No. 3 patterns, and the game device constantly pays out a 1000 credit. In the No. 1 pattern, the extended device pays out a 500 credit independently of the game device, and therefore a total award to be paid out to a player is a 1500 credit. On the other hand, in the No. 2 pattern, the extended device adds a function of multiplying by 3 a payout determined by the game device, and therefore the total award is a 3000 credit, i.e., 1000 (“1000” due to the game device) multiplied by 3 (“×3” due to the extended device). As described, the extended device also has a function of multiplying by some number a payout determined by the game device.

Further, in the No. 3 pattern, the extended device issues a coupon ticket independently of the game device, and therefore an award finally obtainable by a player is a 1000 credit plus the coupon ticket. The additional payout by the extended device is not the coupon ticket, but may be a complementary ticket, gift certificate, cash, point, ticket (meal voucher, etc.) or the like.

As above, the functions and games the extended device can add have been described, however, the extended device is not limited to the above. For example, the number of functions the extended device can add to one symbol may not necessarily be one, but any number of functions, such as a jackpot symbol function and wild symbol function, may be added at once. Also, the number of symbols to which the extended device can add functions is not one, but predetermined functions may be added to two or more symbols. In this case, the functions to be added to the two or more symbols may be the same, or different. Further, the extended device may add a condition to a trigger condition defined by the game device to finally change the entire trigger condition.

Also, a game executed by the game device is not only a reel game, but various games such as a card game and keno game are executable. The extended device can add a function to a symbol present in any of the various games, and further add a game element (such as a secondary game). For example, in a poker game, a four-card hand may be made as a result of the same three cards shown by the game device and the same one further shown by the extended device, or other hand may be made.

Note that, in the present invention, the addition of a function or game element by the extended device is described; however, a unit to execute the additional function or game element may be essentially the extended unit. It should be appreciated that the unit to execute the additional function or game element may be any device other than the extended device.

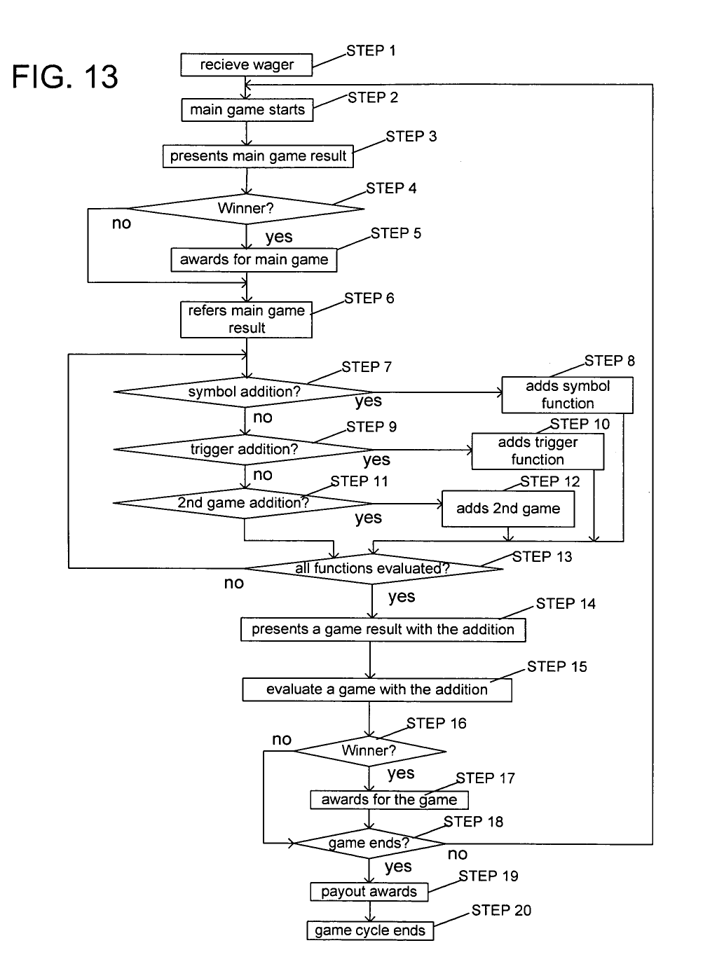

Next, operations performed by the gaming machine according to the present invention are described. FIG. 13 is an example of a flowchart of the operations performed by the gaming machine according to the present invention. In FIG. 13, after the gaming machine has first received a wager (Step 1), the game device starts a main game (Step 2). After the main game has been played, a result of the main game is presented (Step 3). Then, it is determined whether or not the result is winning (Step 4). When the main game result is winning, an award is determined (Step 5). On the other hand, if the main game result is not winning, and the award is determined, the extended device refers to the main game result (Step 6).

After the extended device has referred to the main game result, the extended device determines content of a function to be added to the game. Upon determination of the items to be added, it is first determined whether or not a new function is added to a symbol used in the game (Step 7), and when applicable, the new function is added to the symbol (Step 8). On the other hand, when not applicable, it is determined whether or not a trigger condition in the game is added (Step 9). When applicable, the trigger condition is added (Step 10). On the other hand, if not applicable, it is determined whether or not a secondary game is added (Step 11). When applicable, the secondary game is added (Step 12).

Finally, it is evaluated whether or not it has been determined whether or not all elements that can be added to the game are added (Step 13). When it has not been evaluated whether or not all the elements are added, it is evaluated whether or not they are again added (Steps 7, 9, and 11). When it is determined that all the elements have been evaluated, a game result including the additional items is presented (Step 14). Subsequently, content of the game including the additional items is evaluated (Step 15), and it is determined whether or not the game content is winning (Step 16). When the game content is winning, an award is paid out (Step 17). On the other hand, when the game content is not winning, and the award is paid out, it is determined whether or not the entire game is ended (Step 18).

When it is determined that the entire game is not ended, the main game is again started (Step 2). When it is determined that the entire game is ended, payout is made to a player (Step 19), and then the game cycle is ended (Step 20). Note that elements to be added to a symbol, other than the function (Step 7), trigger condition (Step 9), and secondary game, include those as described above, and the additional elements are not limited to the three items. Also, it is not indispensable to evaluate the three elements, but only one or two of them may be evaluated.

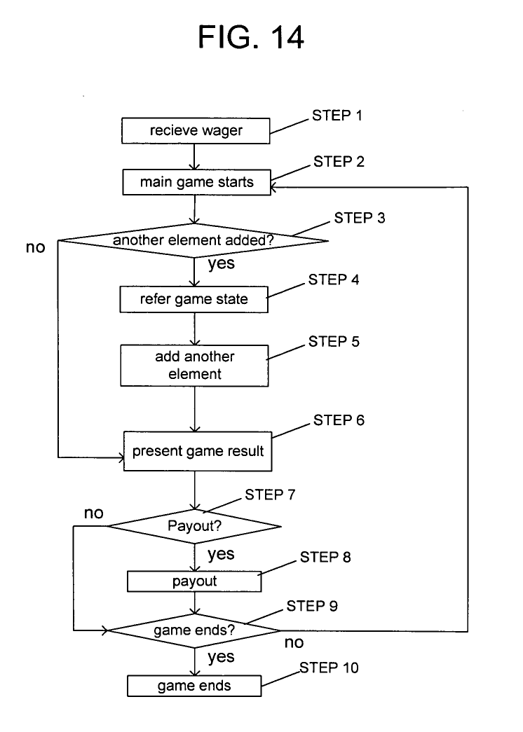

FIG. 14 is an example of a flowchart of operations performed by the gaming machine according to the present invention. In FIG. 14, after the gaming machine has first received a wager (Step 1), the game device starts a main game (Step 2). After the main game has been started, it is determined whether or not the extended device adds the other element to the main game (Step 3). When the other element is added, the extended device refers to content of the main game (Step 4), and then adds the other element to the main game (Step 5). In either case of adding or not adding the other element, a result of the main game is presented (Step 6).

After the main game result has been presented, it is determined whether or not payout is made on the basis of the result (Step 7). When it is determined that the payout is made, the payout is made to a player (Step 8). After the payout has been or has not been made, it is determined whether or not the entire game is ended (Step 9). When it is determined that the entire game is not ended, the main game is again started (Step 2). When it is determined that the entire game is ended, the game cycle is ended (Step 10).

As above, the gaming machine according to the present invention has been described; however, it goes without saying that the present invention is not limited to the above, but as far as an embodiment has an essential part of the present invention, the embodiment falls within the scope of rights of the present invention even if it is embodied in any configuration.

What is claimed is:

1. A gaming machine for providing a game play and a payout according to a game result, comprising:
a storage device, which stores a game using a symbol with a function;
an executor, which executes the game; and
an extended device, which adds other function to the symbol,
wherein the extended device works independently of the executor.

2. A gaming machine of claim 1, wherein the extended device adds the other function to the symbol to play a role as a wild symbol or a jackpot symbol.

3. A gaming machine of claim 1, wherein the extended device adds the other function for starting a secondary game.

4. A gaming machine of claim 3, wherein the secondary game is a jackpot game or a roulette game.

5. A gaming machine of claim 1, wherein the executor executes the game with a trigger condition and the extended device adds another trigger condition to the trigger condition.

6. A gaming machine of claim 1, further comprising:
a processor which synchronizes a play cycle between the executor and the extended device.

7. A gaming machine of claim 1, wherein the extended device implements the other function added to the symbol.

8. A gaming system for providing game play on a display and paying out award, comprising:
a gaming device, including;
(i) a storage device, which stores a game using symbols with function; and
(ii) an executor, which executes the game on the display, and
a controller, which adds other function to the symbols,
wherein the controller works independently of the gaming device.

9. A gaming system of claim 8, further comprising:
a managing system,
wherein the gaming device transmits play activity information to the managing system, and the managing system transmits operating information related to the other function to the controller.

10. A gaming system of claim 8, wherein the controller adds the other function for paying out additional award when the award is pay out according to the game play.

11. A gaming system of claim 10, wherein the total of the award and additional award is in multiples of the award.

12. A gaming system of claim 8, wherein the controller adds the other function for providing a coupon or a complimentary ticket.

13. A gaming system of claim 8, wherein the controller implements the other function added to the symbols.

14. A method for playing a game, comprising the steps of:
receiving wager;
presenting a first game with a set of symbols by a first means;
adding element to the first game by a second means;
playing a second game, which has the element added to the first game;
analyzing outcome of the second game;
determining if the outcome is winning outcome; and
awarding a reward when the outcome is winning outcome,
wherein the first means works independently of the second means.

15. A method of claim 14, further comprising the steps of:
presenting a symbol with a function by the first means; and
adding other function to the symbol by the second means.

16. A method of claim 14, wherein the element is a bonus game.

17. A method of claim 14, wherein the bonus game is a jackpot game or a roulette game.

18. A method of claim 14, further comprising the steps of:
presenting a set of symbols with a trigger condition by the first means; and
adding another trigger condition to the trigger condition by the second means.

19. A method of claim 14, wherein the step of adding the element includes the step of adding an element for paying out additional award when the award is paid out according to the game play.

20. A method of claim 14, further comprising the step of:
implementing the element by the second means.
